(19) United States
(12) Patent Application Publication
(10) Pub. No.: US 2013/0282522 A1
(43) Pub. Date: Oct. 24, 2013

(54) REAL-TIME DIGITAL INVENTORY SYSTEMS AND METHODS

(71) Applicant: UNIVERSITY OF FLORIDA RESEARCH FOUNDATION, INC., Gainesville, FL (US)

(72) Inventor: Mohamed Nabil Hassan, Gainesville, FL (US)

(21) Appl. No.: 13/866,129

(22) Filed: Apr. 19, 2013

Related U.S. Application Data
(60) Provisional application No. 61/635,938, filed on Apr. 20, 2012.

(51) Int. Cl. G06Q 10/08

(52) U.S. Cl. CPC G06Q 10/087
USPC 705/26.9; 235/385

(57) ABSTRACT

In one embodiment, a system comprising: a communications device, comprising: a memory comprising logic and a user-configured data structure; and a processor configured with the logic to: receive real-time information corresponding to a plurality of purchasable products located in a store, the real-time information received from a node located proximal to the purchasable products; match product information stored in the data structure with the received real-time information; and identify to a user a location within the store of a product with the stored product information that matches the received real-time information.

### CROSS REFERENCE TO RELATED APPLICATIONS

This application claims priority to co-pending U.S. provisional application entitled “REAL-TIME DIGITAL INVENTORY SYSTEMS AND METHODS” having Ser. No. 61/635,938, filed Apr. 20, 2012, the entirety of which is hereby incorporated by reference.

### TECHNICAL FIELD

The present disclosure is generally related to communication networks, and, more particularly, is related to communication networks in a retail environment.

### BACKGROUND

Wireless communication devices have evolved significantly in popularity and sophistication. From their inception, such devices provided user's with a practical alternative to landline phones, giving the user the ability to communicate with others at times and/or places where landline communication is more prohibitive. One benefit to wireless communication devices is the ever-expanding types of mobile applications, such as those found in smartphones, which enable a user to, among other functions, access the Internet. With ready access to the Internet, the user can quickly obtain useful information, such as directions to a nearby restaurant, or product searches among retailer websites to discern availability and/or the best price. Despite these advances, many of the current systems in the context of the retail environment are still cumbersome.

### SUMMARY

In one embodiment, a system comprising: a communications device, comprising: a memory comprising logic and a user-configured data structure; and a processor configured with the logic to: receive real-time information corresponding to a plurality of purchasable products located in a store, the real-time information received from a node located proximal to the purchasable products; match product information stored in the data structure with the received real-time information; and identify to a user a location within the store of a product with the stored product information that matches the received real-time information.

Other systems, methods, features, and advantages of the present disclosure will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of an example network environment in which an embodiment of a real-time digital inventory system is implemented.

FIG. 2 is a screen diagram that illustrates an example web page of an embodiment of a real-time digital inventory system that enables a user to configure a shopping list, among other functions.

FIGS. 3-4 are screen diagrams that illustrate an example web page of an embodiment of a real-time digital inventory system that enables a user to select a retail store for which a shopping list may be configured.

FIG. 5 is a screen diagram that illustrates an example web page of an embodiment of a real-time digital inventory system that enables a user to configure a shopping list.

FIG. 6 is a schematic diagram that illustrates a shopper walking along a store aisle interacting with an embodiment of a real-time digital inventory system.

FIG. 7 is a schematic diagram of an example wireless communication device that functions as a component of an embodiment of a real-time digital inventory system to provide the shopper with real-time information of shopping list items that are present in a given aisle in which the shopper is walking.

FIG. 8 is a schematic diagram that illustrates a shopper walking along a store aisle interacting with an embodiment of a real-time digital inventory system.

FIG. 9 is a screen diagram that illustrates an example embodiment of a graphical user interface for presentation on a wireless communication device display screen of an embodiment of a real-time digital inventory system, the display screen providing a plan view of a map of the store in which the shopper is currently shopping and locations of the configured shopping list items.

FIG. 10 is a block diagram that illustrates an embodiment of a real-time digital inventory system configured as a wireless communications device.

FIG. 11 is a block diagram that illustrates an embodiment of a real-time digital inventory system configured as a server device.

FIG. 12 is a flow diagram that illustrates an embodiment of a real-time digital inventory method from the perspective of a wireless communications device of a user.

FIG. 13 is a flow diagram that illustrates an embodiment of a real-time digital inventory method from the perspective of a wireless communications device embodied as a node.

Appendix “A”, which provides further information pertaining to an embodiment of a time/temperature (TTI) system.

### DETAILED DESCRIPTION

Certain embodiments of an invention comprising a real-time digital inventory system and method (referred to herein also as SuperCoup) are disclosed that facilitate consumer purchases through the use of a client-server approach and wireless technology. In one embodiment, a user plans out his or her shopping list (e.g., for a retail store, such as a grocery store, clothes store, hardware store, etc.) using a web page for a retail store or third party service on the Internet. For instance, the user may populate a shopping list presented on a web page. In this process, the user may generate a list of needed items, and perform price comparisons for similar product among local, (or remote, in some circumstances) alternative stores. Once complete, the user may download the list to his or her wireless communications device, such as a smartphone. In some embodiments, the download may occur when the user enters the store, as described further below. At the store, the user accesses his or her smartphone (or in some embodiments, the store communications device coupled to a cart or basket) for the shopping list, and the smartphone interacts with the wireless network system of the store to access real-time product information (versus pre-loaded data sets) to guide the user to his or her purchases from, and even beyond, the list.

In some embodiments, a real-time digital inventory system and method may be integrated with a time/temperature (TTI) system, or in some embodiments, a TTI system and method may be implemented without the real-time digital inventory system. In one embodiment, the TTI system comprises one or a combination of features/functions, including measuring temperature and time, performing calculations to determine remaining “shelf-life” (based on product specific algorithms), or transmitting this data wirelessly to a location of choice (e.g., cell phone node or tower, base station, internet, mobile device, access point, etc.). In one embodiment, a TTI system includes a unit comprising a power generator, microprocessor, microstorage, antennae and peripherals. Peripherals may include some or all of the following: LED indicator lights, temperature sensor, humidity sensor, accelerometers, gas or vapor sensors, expanded data storage, timers, variable antennae arrays. A customized chip design for the TTI application enables for the real time acquisition of local environmental conditions which are stored on the chip. In some embodiments, the chip may be replaced with other logic (e.g., hardware, software, or a combination of hardware and software). The data is then transmitted wirelessly to a server, internet domain or mobile device where the raw data is transformed based on product specific algorithms. The transformed data is then transmitted back to a graphical user interface where a customized display indicates the “freshness” and suitability of the monitored product for use or consumption following transportation and storage.

In some embodiments, the TTI software is merged with a real-time digital inventory system, enabling inventory and “competitive freshness” or “verifiable freshness” forecasting for the manufacturer, retailer and/or consumer. The combined TTI and real-time digital inventory software enables a store manager to begin discounting perishable goods in advance of their expiration date or store-mandated quality parameters. The inventory metrics track these discounts, which can be transmitted to consumers' mobile devices as digital coupons when they are located near the merchandise to spur impulse purchases. The reductions in inventory contrasted according to the offered discounts can be tracked in real time offering “on the fly” adjustment at a local, regional or national level. One advantage is cradle to grave accountability of the supply chain for perishable goods. Merging of the TTI with real-time digital inventory and digital couponing technology allows for mandatory recalls of perishable goods to be sent directly to the consumers/purchasers mobile device.

In addition, with the real-time digital inventory technology of SuperCoup backend, these metrics may be tracked and the information collated into detailed reports. These reports are applicable to suppliers, manufacturers and retailers alike, while making the temperature and freshness information to the consumer via a web and mobile app. In some embodiments, the TTI device is about the size of a quarter. Further information pertaining to one or more embodiments are disclosed in the attached appendix A, incorporated herein in its entirety.

When comparing at least the real-time digital inventory system with conventional methods, existing systems may enable purchases from home over the Internet, or price comparisons while in a store, but none of these systems enables the user to traverse the store while the smartphone essentially does the shopping for him or her. In other words, systems exist where the user actively scans bar codes using known radio frequency identification (RFID) technology residing as part of the image capture feature of a smartphone, but no systems exist where the user's smartphone passively receives real-time information (e.g., without the user gesturing his or her hand to position the smartphone within range of the scan code of the purchasable item or product) to assist the user in purchases from the list and beyond.

Having broadly summarized certain features of real-time digital inventory systems and methods and TTI systems and methods of the present disclosure, reference will now be made in detail to the description of the disclosure as illustrated in the drawings. While the disclosure is described in connection with these drawings, there is no intent to limit the disclosure to the embodiment or embodiments disclosed herein. For instance, though described in the context of a wireless communications device embodied in a smartphone and a grocery store as an example environment where the system may be employed, it should be appreciated within the context of the present disclosure that other wireless communications devices (e.g., laptops, personal digital assistants (PDAs), note pads, etc.) may be used in the same or different retail environments. Further, though the focus is on implementation of the real-time digital inventory system, it should be appreciated that one or more embodiments of a TTI system may employ the same or similar principles as disclosed herein, except where noted in the appendix A. Although the description identifies or describes specifics of one or more embodiments, such specifics are not necessarily part of every embodiment, nor are all various stated advantages associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

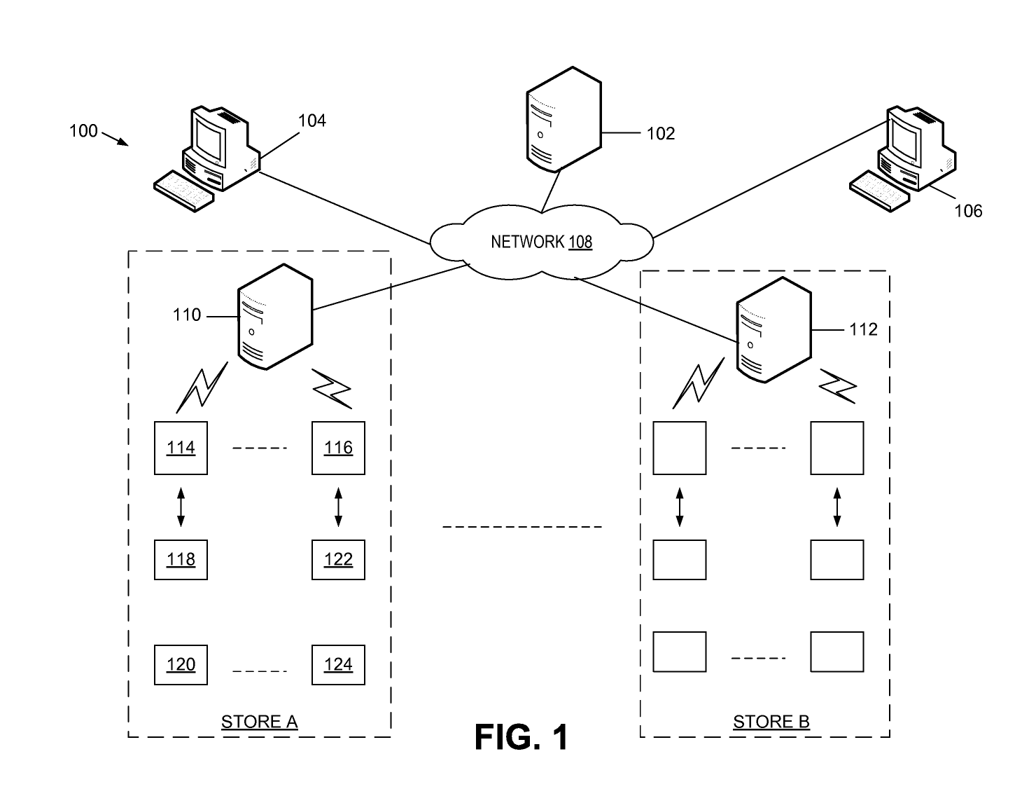

Referring now to FIG. 1, shown is a block diagram of an example network environment 100 in which an embodiment of a real-time digital inventory system is implemented. One having ordinary skill in the art should appreciate in the context of the present disclosure that the example environment 100 is merely illustrative, and that some embodiments of a real-time digital inventory system may be implemented in other environments. As depicted in FIG. 1, the network environment 100 comprises a main server device 102 and a plurality of user computers 104 and 106 coupled to one another over one or more networks, such as a wide area network 108. The wide area network may comprise a plurality of networks, and includes the Internet. Also coupled to the wide area network 108 are the server devices associated with one or a plurality of stores, such as server devices 110 and 112 corresponding respectively to store A and store B. These server devices 110 and 112 may be the property of the store, or a third party's server devices. At store A, the server device 110 is in wireless communication with one or more repeaters, such as repeaters 114 and 116. In some embodiments, the server devices 110 and 112 may be coupled in a wired arrangement with the repeaters 114 and 116. Each repeater 114 and 116 may be associated with its own row or aisle of product, and hence responsible for maintaining the inventory for the given aisle or row. In some embodiments, each repeater may handle multiple aisles. In one embodiment, the repeater 114 is operably coupled (e.g., wirelessly, or wired in some embodiments) to one or more nodes, such as nodes 118 and 120. Each of the nodes 118 and 120 comprises communication functionality and the ability to receive real-time product information over a given range from a retailer employee or contractor (e.g., from his or her inventory scanner device) and convey that information to the server device 110 through the repeater 114. In some embodiments, the repeater 114 may be omitted and the communication may be achieved directly (or through another device, such as a router) from the nodes 118 and 120. Similarly, the repeater 116 is coupled (e.g., wirelessly, or wired in some embodiments) to one or more nodes 122 and 124, which comprises communication functionality and the ability to receive real-time product information and convey that information to the server device 110 through the repeater 116. Similar functionality is depicted in FIG. 1 for store B, and hence discussion of the same is omitted here for brevity.

Although certain quantities of devices are depicted in FIG. 1, it should be appreciated that such quantities are for illustrative purposes (e.g., such as represented by the dashed lines), and that fewer or additional quantities of these and other devices (e.g., routers, gateways, etc.) are contemplated to be within the scope of the disclosure. For instance, in some embodiments, the nodes (e.g., nodes 118, 120) may be omitted, and a different type of wireless scheme may be used that communicates and receives product information (and other information) through the use of wireless routers.

In one example operation, using store A as an example shopping locale, a user accesses a web site dedicated to providing real-time digital inventory functionality, such as provided by the server device 102 and/or server devices 110 and 112, and accesses one or more web pages to enter his or her shopping list through browser software on the computer 104. Note that the computer 104 is shown as a personal computer, though other types of computers or computing devices may be used, including laptops. While accessing the web site, the user can first select one or more desired destinations (e.g., provided from the server device 102), such as a desired retail store including a grocery store, clothing store, hardware store, etc., perform price comparisons, and search for desired items, among other tasks. The computer 104 communicates with the server device 110 for product information (e.g., price per unit, brand name, etc.), or in some embodiments, such information may be accessed from the main server device 102, which is in communication with the various retail server devices, such as server devices 110 and 112.

Upon completing the list, the user may save it, and in some embodiments, download it to his or her smartphone for use prior to, or during, shopping. For instance, upon entering the store, the smartphone may awaken and communicate with the server device 110, registering with the server device 110 in a handshaking operation to obtain access to the user's profile. In some embodiments, upon completion of the handshaking process, the smartphone may communicate a request for the latest shopping list (if not downloaded at the time of preparing the shopping list from the computer 104), or receive it automatically upon registering its presence with the server device 110. From the smartphone, the user may access a map of the store to determine the locations of the various items on the list (or search for other items), and then traverse the aisles of the store while the smartphone continually communicates with the nodes 118, 120, 122, and 124 to have an up-to-date status of real-time information regarding the purchasable products, such as the pricing, location (e.g., relative to the user), coupons, special deals, complementary products, etc. The map may be created at the time the user accessed the web page from the computer 104, and either downloaded then or saved for a later download (e.g., when the user enters the store). In some embodiments, the map may be created in real-time when the user enters the store. In either case, the map may be updated based on impulse purchases, for instance.

The server devices 110 (and 112) store, among other information, a data structure (e.g., database or other data structure) of inventory that is continually updated when the nodes 118, 120, 122, and 124 (and for the server device 112, the associated nodes) are updated, the nodes providing signaling to the repeaters 114 and 116, which relays the updates to the server 110. Such updates may occur, for instance, when an employee of the store (or third party) stocks to and/or removes product from the shelves and scans the items along the aisles of the store with an inventory scanning device, the scanned information captured by the nodes 118, 120, 122, and 124 when within range (e.g., when the employee is scanning items in an aisle). Each node 118, 120, 122, and 124 may each store inventory data for its own unique, dedicated area or section of a given aisle and/or share inventory information for a given aisle among one or more of the nodes. In some embodiments, the nodes 118, 120, 122, and 124 may serve more than one aisle. In some embodiments, the updates also occur by virtue of the user (i.e., the shopper) removing items off the shelf and into a cart or basket (e.g., shopping bag). As explained further below, when a shopper pulls a product off the shelf and deposits in his or her cart, basket, or bag, the smartphone may communicate this event to the closest node, such as node 118. The node 118 adjusts its data structure of inventories items. The node 118 also communicates the removal to the repeater 114, which updates the server device 110 with the removal information (i.e., updated inventory count) so that adjustment in the quantity of product is achieved at the server device 110.

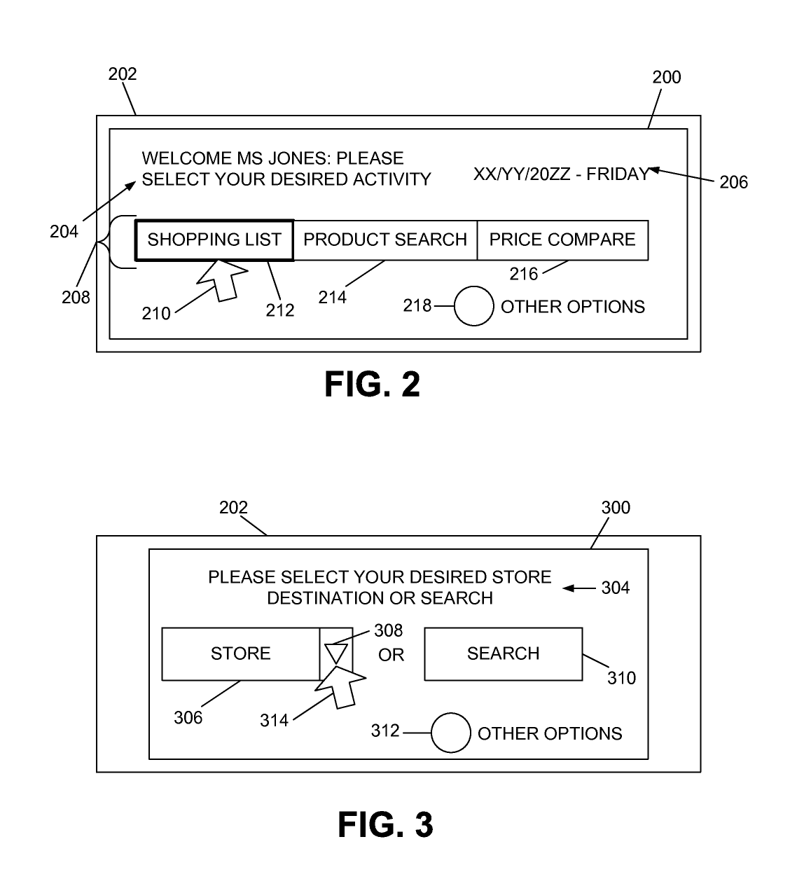

Having described a general manner of operation according to certain embodiments of a real-time digital inventory system, attention is directed to FIGS. 2-5, which illustrate various example web pages that a user may interact with to prepare the shopping list, the web pages also enabling other functionality as mentioned below. One having ordinary skill in the art should appreciate in the context of the present disclosure that the example web pages shown in FIGS. 2-5 are merely illustrative, and that some embodiments of a real-time digital inventory system may use interfaces of different arrangements and/or information. Referring to FIG. 2, shown is an example web page 200 presented on a display screen 202, such as that of the computer 104 or 106 (FIG. 1), or of another device. In some embodiments, the web page 200 may be accessed from other devices, such as from his or her smartphone, and used to configure a shopping list and/or obtain the benefit of other features of the web page 200. In this example, the web page 200 comprises a personalized message banner 204 and a date portion 206. The message banner 204 recites, “welcome Ms Jones: please select your desired activity.” From this message banner 204, the user is prompted to select one of a plurality of button icons 208 with a cursor 210 that may be manipulated by a mouse, pointing device, or other user interface mechanism well known to those having ordinary skill in the art. In some embodiments, a touch screen interface or audio interface may be used and hence the cursor 210 may be omitted.

The button icons 208 include a shopping list icon 212, product search icon 214, and price comparison icon 216. Selection of the product search icon 214 may cause a sub-window, drop down menu, or different page to be invoked, where the user may enter the first few letters of a product to cause the generation of a plurality of options, much like current search screens (e.g., somewhat similar to Google search functions). The price comparison icon 216, also when selected, may be replaced with another web page, drop down menu, or sub-window to provide the user with the ability to compare one or more products (e.g., by unit price) of a store to the same product (e.g., of a same or different brand) sold elsewhere. Other options may be selected by the user selecting an other options button icon 218, which may provide a web page or other interface that provides information pertinent to the user during his or her shopping travels, such as information of available coupons, special deals, or generally, other discounts.

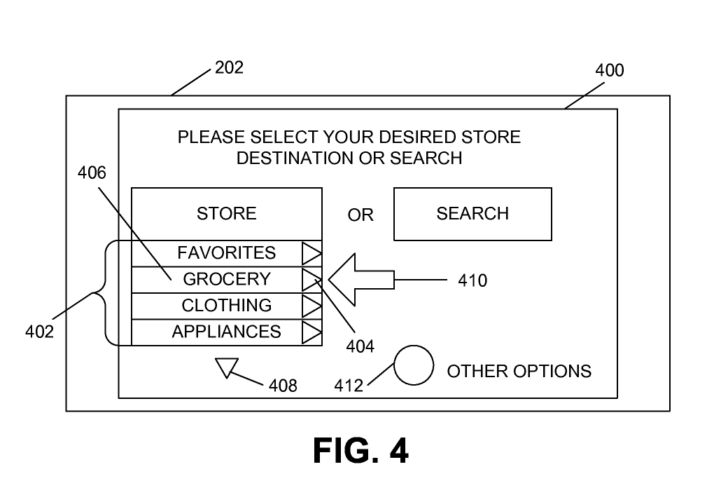

With regard to FIG. 3, shown is an example web page 300 on the display screen 202 resulting from the user selecting the shopping list icon 212 with the cursor 210. The web page 300 comprises a message banner 304 that instructs the user on use of the web page 300. For instance, the message banner 304 recites, “please select your desired store destination or search.” In this example, the user has a number of options that include a store button icon 306 having a scroll down icon 308 and a search button icon 310 that enables the ability to search for a given retail store. The user also has the ability to select the other options button icon 312, which may enable the user to go back to the previous web page 200, provide a help menu, among other features. In the depicted example, the user uses the cursor 314 to select the scroll down icon 308 of the store button icon 306 to select from a list of retail stores, as shown in an example web page 400 of FIG. 4.

As shown in FIG. 4, the web page 400 is presented on the display screen 202, and is essentially the same as the web page 300 except for the presentation of a drop down menu 402 presenting a list of types of retail stores, each with a corresponding refining icon, such as refining icon 404 of a grocery button icon 406. The drop down menu 402 includes such categories as favorites (e.g., the user's favorite retail stores under one or more categories), grocery, clothing, appliances, among others not shown as suggested by the down arrow icon 408. Selection of any of the refining icons from each category button icon provides a further refinement of the available stores in the selected category, which may be presented as another drop down menu. Note that drop down menus 402 are presented for purposes of illustration, and other mechanisms for presenting a further refinement of a selected category are contemplated to be within the scope of the disclosure. In the example depicted in FIG. 4, the user manipulates a cursor 410 in proximity to the grocery button icon 406, and in particular, to the selection of the refining icon 404 to select from a list of grocery stores. Note that the list may be generated based on a default, predetermined area coverage, say ten miles from the user's residence. The user may adjust this and/or other criteria using an other options button icon 412 or other mechanisms, such as through a start-up or profile menu.

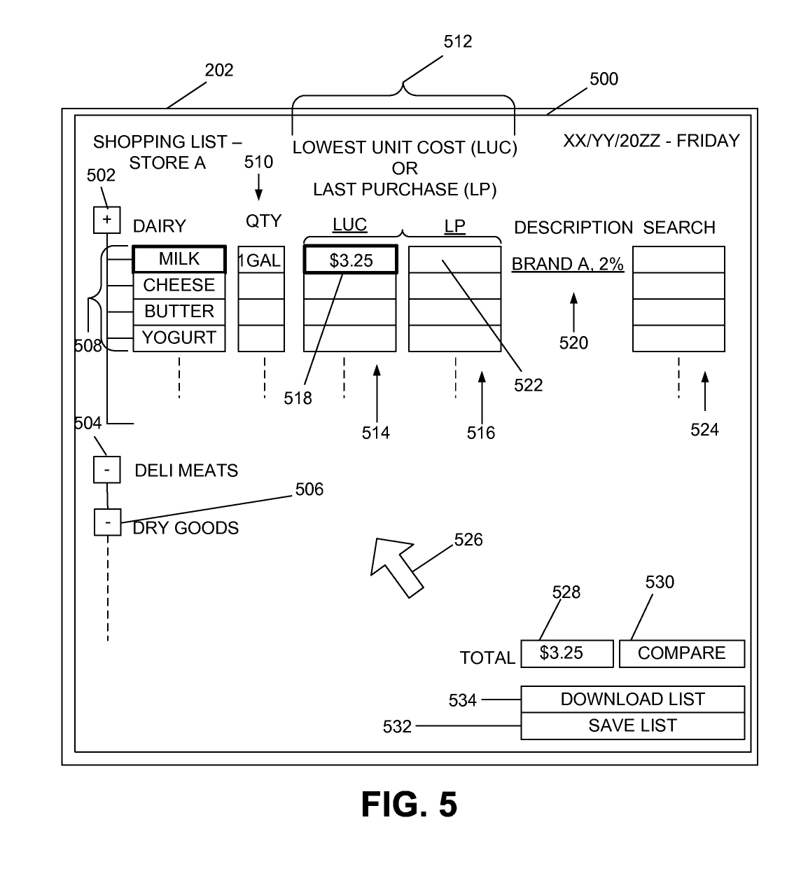

Assume the user selected grocery store A from another drop down menu generated from the web page 400. Referring now to FIG. 5, shown is an example shopping list web page 500 presented on the display screen 202. The shopping list web page 500 comprises various product categories that are automatically presented on the page 500 based on the inventory as determined from the server device 110. In some embodiments, the web page 500 (and the other web pages) may be populated from the main server device 102 accessing (or being provided with) real-time information (e.g., inventory) of the servers from various retail stores, such as the server devices 110 and 112 from stores A and B, respectively. In this example shopping list web page 500, only a subset of the product categories are shown for brevity, including dairy 502, deli meats 504, and dry goods 506. The product categories are presented as a collapsible tree structure, enabling the user to quickly navigate among the plural categories of product and expand the category if product from that particular category is desired. Other formats or arrangements may be used in some embodiments. The dairy category 502 has been expanded to show plural sub-categories 508 of dairy products, such as milk, cheese, butter, yogurt, among others (as represented by the dashed lines). Additional columns of information are also presented for each of the sub-categories 508, such as a quantity column 510 (where the user may select each quantity box to toggle to different quantity measures than the default), and a lowest unit cost (LUC) and last purchase (LP) column 512 that includes respective sub-columns for the lowest unit cost 514 and the last purchase 516. The user may select a given entry in one of these sub-columns 514 and 516 based on whether the user wants the lowest cost milk or the last-purchased brand, respectively. In the depicted example, the user selects (as shown by bolded option 518) the lowest cost milk for the given quantity (e.g., one (1) gallon), which is at $3.25 per gallon and is identified as Brand A, 2% in description column 520. Should the user choose the last purchase, a unit price is populated in the box 522 instead, and the description may or may not be different in the description column 520 (depending on whether Brand A was the last purchase by the user). The user may choose to have a different brand than the lowest cost or last purchased brand, and hence may select the corresponding search button icon 524. Note that selections may be made via a cursor 526, among other selecting mechanisms, such as audibly.

The shopping list web page 500 also includes additional information, such as a running total box 528 that maintains a tally of the total price of the selected items (in this example, only one item has been selected), and a compare button icon 530 that enables the user to compare the completed list with the same or similar items in another retail store, or in some embodiments, provide a price comparison to a currently selected item (i.e., not delay comparison until the list is completed).

When the user has completed populating the shopping list, he or she may choose to save the list by selecting the save list button icon 532, and/or download the list to his or her computer 104 (FIG. 1) or smartphone by selecting the download list button icon 534. For instance, the user may download the list to the home computer 104 (or a computer at work or elsewhere) and couple the smartphone (e.g., via a USB connection or otherwise) to the computer 104 to download the list to the smartphone. In some embodiments, the user may choose to save the list and later access the list (e.g., receive the downloaded list) when in the store.

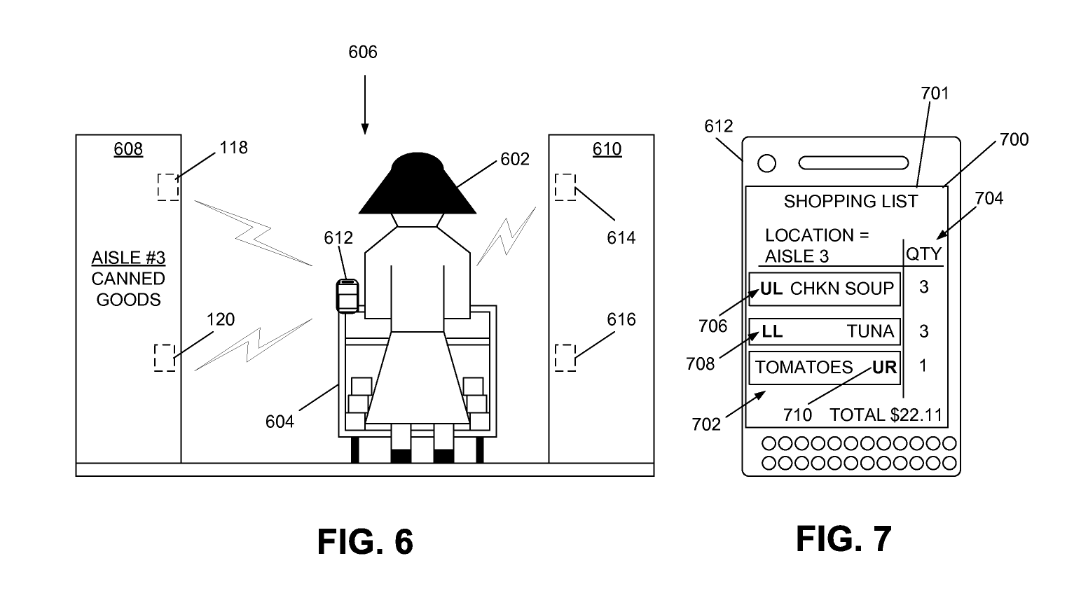

Having described one component (e.g., shopping list preparation or configuration) of certain embodiments of a real time digital inventory system, attention is directed to FIG. 6, which illustrates a user (e.g., shopper) 602 traversing an aisle of a store with her smartphone cooperating with the communications network of the store. As shown, the user 602 is pushing a cart 604 through an aisle 606 at the store, each side of the aisle 606 in this depicted example comprising shelves 608 and 610 stocked with product (e.g., purchasable product or groceries). Note that the description below emphasizes a wheeled cart, with the understanding that a basket is contemplated as another form of cart, albeit without wheels. Coupled to the cart 604 is a smartphone 612 via a cradling assembly that enables the user to secure the smartphone 612 to the cart 604. Note that securing the smartphone 612 to the cart 604 is not necessary, and that in some embodiments, the user may prefer to wear the smartphone 612 on his or her person or carry in his or her hand (or wear as a headset). As illustrated, the smartphone 612 is in communication with plural nodes, including nodes 118, 120 previously mentioned and nodes 614, and 616. Although shown with a plurality of nodes in a given aisle, it should be appreciated that in some embodiments, a single node may cover one or more aisles.

The smartphone 612 is equipped for wireless communication (e.g., WiFi using an ANT or similar protocol, 3G, 4G, Bluetooth, etc.), and activates the nodes 118, 120, 614, and 616 when within a predetermined range of the nodes, enabling the receipt by the smartphone 612 of real-time product information (and discount information, such as coupons) and enabling a determination of the location of the shelved product. In some embodiments, the nodes 118, 120, 614, and 616 may continually broadcast real-time information without being prompted by the smartphone 612. Again, the nodes 118, 120, 614, and 616 provide the smartphone 612 with real-time information corresponding to purchasable products that are located on the shelves 608 and 610. In one embodiment, the nodes 118, 120, 614, and 616 may store inventory information for the particular aisle in which the node resides or is associated, as well as location information that associates the nodes 118, 120, 614, and 616 to a unique aisle number. In some embodiments, one or more of the nodes 118, 120, 614, and 616 may not store the inventory information, but rather, access the server device 110 (e.g., for store A) or a master node for the product information for that aisle and communicate the same (or a portion thereof) to the smartphone 612. In one embodiment, the smartphone 612 communicates with the nodes 118, 120, 614, and 616 to download the real-time product information. The smartphone 612 receives the real-time information from the nodes 118, 120, 614, and 616, and is enabled to compare the real-time information with the stored information (e.g., stored in the smartphone 612) pertaining to the list of products populating the user's shopping list. In some embodiments, the nodes 118, 120, 614, and 616 may communicate a subset of the stocked product information based on knowledge (e.g., via identification of the user's communications device) of the profile and corresponding shopping list. Those stored items that match the received real-time information may be highlighted or otherwise identified on the smartphone display screen, alerting the user 602 to the location of the product from her shopping list.

Although the nodes 118, 120, 614, and 616 are shown residing in the shelves 608 and 610, it should be appreciated in the context of the present disclosure that the nodes 118, 120, 614, and 616 may be located in additional or other locations, including in the floor and/or suspended from the ceiling. Further, each node 118, 120, 614, and 616 may operate independently of one another, in a peer-to-peer communication arrangement, or in a master-slave arrangement, the latter of which enables the slave nodes to operate with a more rudimentary architecture than that provided in, say, the master node.

Digressing briefly, and as indicated above, the user's smartphone 612 and the server device 110, assuming an aisle in store A is currently being traversed by the user 602, enter a period of awareness of each device where various communication protocols are performed. Certain embodiments of the real-time digital inventory system provide for a wireless network, such as WiFi, 3G, 4G, Bluetooth, among others, where the smartphone 612 registers with the server device 110, and the server device 110 accesses a profile of the user 602. For instance, repeaters may be used toward the entrance to communicate with the smartphone 612. Such repeaters may also be used to populate a map in the smartphone 612, the map either previously downloaded to the smartphone 612 or downloaded when the user enters the store. In some embodiments, the smartphone 612 may generate the map based on the information conveyed by the nodes and repeaters and server device, and in some embodiments, continually update the map while the shopper traverses the store. Assuming one (i.e., a map) generated at the server device 110, based on the profile, the server device 110 may access the shopping list of the user 602 and download the list if not already downloaded to the smartphone 612. The user's location within the store, as corresponding to the smartphone location of the user 602 within the store, is determined based on one of many well-known techniques, such as triangulation using the nodes 118, 120, 604, and/or 616 (e.g., RFID or other RF or IR based triangulation methods, and/or GPS), or in some embodiments, based on triangulation methods that omit the nodes or use nodes that are not equipped with RFID technology.

Referring to FIG. 7, shown is an example embodiment of a graphical user interface 700 that is presented on a display screen 701 of the smartphone 612 for the user while traversing the aisle 606 in FIG. 6. One having ordinary skill in the art should appreciate in the context of the present disclosure that the example graphical user interface 700 shown in FIG. 7 is merely illustrative, and that some embodiments of a real-time digital inventory system may use other interfaces of different arrangements and/or information for the smartphone 612. In the example depicted in FIG. 7, the graphical user interface 700 comprises the portion of the shopping list corresponding to products available in aisle 3, which is the aisle 606 in FIG. 6 in which the user 602 is currently traversing. The graphical user interface 700 in this example lists chicken soup, tuna, and tomatoes in the shopping list column 702, and a quantity for each in the quantity column 704. In other words, in cooperation with one or more of the nodes 118, 120, 614, and 616, the smartphone 612 automatically presents the shopping list items for aisle 3 that were previously configured (e.g., in FIG. 5), as well as the configured quantities desired by the user 602. In other words, the shopping list items previously configured are automatically identified as being present in the aisle 606 currently traversed, and hence located without any prompting input by the user since the nodes 118, 120, 614, and 616 are in wireless communication with the smartphone 612. In some embodiments, for each item of the list presented in the graphical user interface 700, the smartphone 612 may present a location identifier, such as UL (upper left) 706, LL (lower left) 708, and UR (upper right) 710 for chicken soup, tuna, and tomatoes, respectively. Stated otherwise, the smartphone 612 provides a location of each item on the shopping list for the currently traversed aisle 606 relative to the user's location.

In some embodiments, the identification (including location) of the products may be audibly presented to the user 602 from the smartphone 612.

Items that are selected by the user 602 from that shopping list may then be checked off from the list by the user 602, or in some embodiments, marked for later pick-up. For instance, in one embodiment, the user may scan the selected item(s) past the smartphone 612 (e.g., equipped with scanner logic, such as through sensor(s) corresponding to the image capture features of the phone) at a time corresponding to placing the selected item into the cart 604. In some embodiments, the user 602 may tap the item on the screen 701 extracted from the shelf (e.g., 608), which “checks off” the selected item from the list (e.g., as opposed to scanning). The taps may be a single tap collectively for the listed quantity, or for each extraction and deposit for the particular item. In some embodiments, the user 602 may speak into a microphone in the smartphone 612 to register the extraction and deposit of the product into the cart 604. The smartphone 612 may then communicate to the node, say node 118, responsible for inventorying the deposited product (e.g., maintaining data in data structure within the node 118) the extraction event, which results in the node 118 decrementing the count of that product from inventory and updating the server device 110 through the repeater 114 (or bypassing the repeater in some embodiments).

In some embodiments, the deposit of the items in the cart 604 may be detected after the deposited item meets or exceeds a predetermined threshold distance from the node responsible for inventorying the deposited product. For instance, when the user 602 deposits the items from the list into the cart 604 and traverses to the next aisle, the node 118 may sense (e.g., sensing the scanning code of the product) that one of the items from its responsible inventory is located a predetermined distance away from the node 118 (signifying that the item has been extracted from the shelf and carried away), and hence decrement the inventory count for those extracted and deposited items, and also communicate the inventory change to the server device 110 in the manner described above.

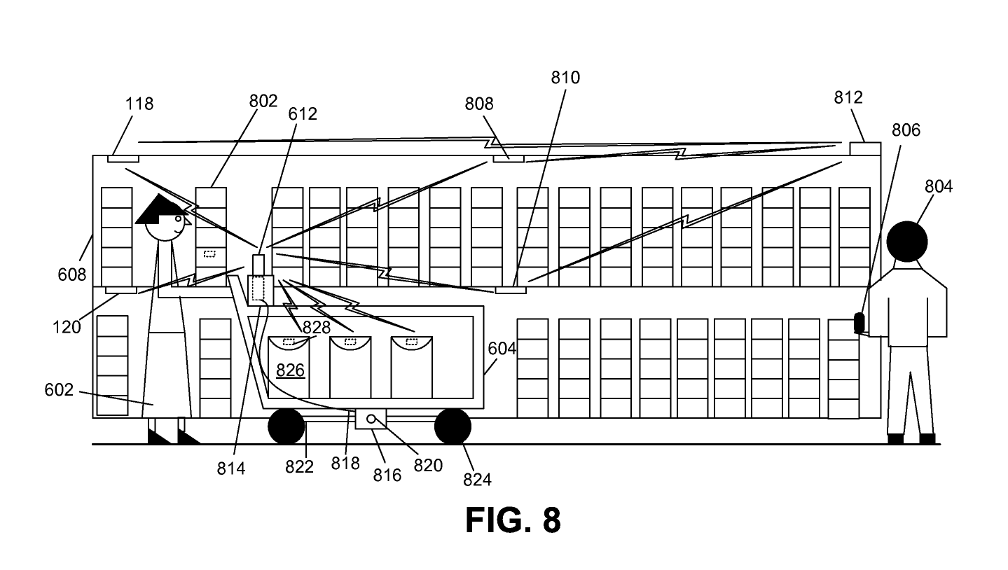

FIG. 8 shows another illustration of the user 602 pushing the cart 604 along an aisle of the store. As shown, the shelf 608 is stocked with a plurality of different products, such as product 802. Also shown is a store employee or store contractor 804 stocking the shelves and using an inventory scanning device or scanner 806 to update the inventory for that aisle. In one embodiment, when the employee 804 updates the inventory (e.g., by adding or removing product), the nodes (e.g., nodes 808 and/or 810) within range of the scanning device 806 also update their data structures. Each of the nodes 118, 120, 808, and 810 communicate the respective updates to a repeater 812 located in one embodiment at one end of the aisle. The repeater 812 may be located proximally to the server device 110 (not shown in FIG. 8), and in wired or wireless communication with the server device 110. The repeater 812 also updates the server device 110 with the change in inventory.

Also shown in FIG. 8 is the cart 604 in further detail. In particular, the cart comprises a cradling assembly or device 814 that detachably secures the smartphone 612 to the cart 604. In one embodiment, the cradling device 814 may be coupled to a recharging apparatus 816 via wiring 818. For instance, the recharging apparatus 816 may comprises a shaft 820 that engages (e.g., sprocket assembly) one or more endless chains 822 running underneath the cart 604 and coupled to one or more axles of the wheels 824. The recharging apparatus 816 converts the mechanical energy provided by virtue of the forward or backward movement of the cart 604 to electrical energy, which is communicated to the cradling device 814 to recharge the smartphone 612. In some embodiments, other mechanisms may be used to recharge the smartphone 612, including solar power, among others.

FIG. 8 also shows a variation in the scheme to track each deposit of the product(s) into the cart 604. For instance, the cart 604 carries one or more removable shopping bags, such as shopping bag 826. Each shopping bag 826 comprises an RF or IR based chip (e.g., RFID chip) 828 that communicates with the smartphone 612 when product is deposited in the bag 826. For instance, when the user 602 deposits a product into the bag 826, the associated chip 828 detects the scanning code or bar code of the product, and communicates the deposit (via signaling) to the smartphone 612, which in turn sends a signal to (e.g., updates) the node, such as node 118. In some embodiments, the chip 828 may communicate the deposit also to the node 118. Note that the user may decide not to use the cart 604, and hence the bag 826 may be used without the cart 604.

Note that the cradling device 814 is depicted as an assembly to secure and recharge the smartphone 612. In some embodiments, the cradling device 814 may embody one or more of the features of the smartphone 612. For instance, in areas where more advanced smartphones are nonexistent, the cradling device may be configured with WiFi, 3G, 4G, Bluetooth, or other like communications capability that assists a less advanced phone coupled thereto, or substitutes for a phone, and hence serves as a communication device with permanent residence on the cart 604.

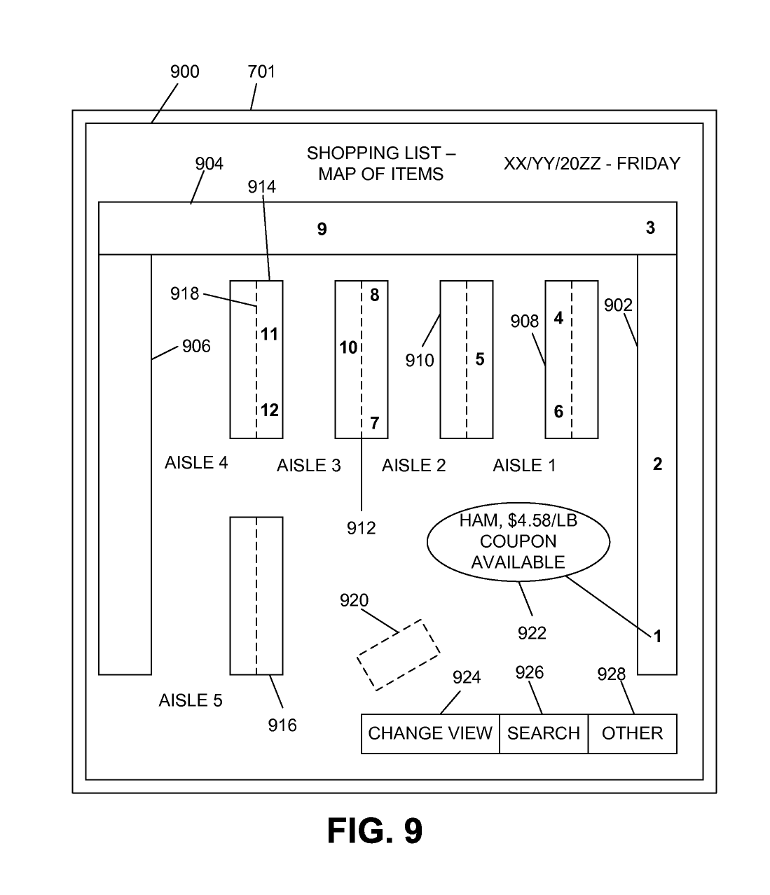

Attention is now directed to FIG. 9, which illustrates an example embodiment of a graphical user interface 900 that is presented on the display screen 701 of the smartphone 612. One having ordinary skill in the art should appreciate in the context of the present disclosure that the example graphical user interface 900 shown in FIG. 9 is merely illustrative, and that some embodiments of a real-time digital inventory system may use other interfaces of different arrangements and/or information for the smartphone 612. The graphical user interface 900 presents to the user 602 (FIG. 6) a map of the store in which the user seeks to fulfill the previously configured shopping list, the map showing a plan view with relevant features or locations of the store depicted using geometric graphics. Note that other views may be presented in some embodiments, including a perspective view, end view, etc. For instance, shelves 902, 904, and 906 are depicted as rectangles located along portions of the perimeter of the interior of the store, the bottom of the map proximal to an entrance of the store and the top of the map proximal to the rear of the store. Located within the interior of the map is a plurality of aisles, such as aisles 1-5. Aisle 1 is bounded in part on opposing sides by shelf structures 908 and 910. Aisle 2 is bounded in part on opposing sides by shelf structures 910 and 912. Aisle 3 is bounded in part on opposing sides by shelf structures 912 and 914. Aisle 4 is bounded in part on opposing sides by shelf structure 914 and shelf 906. Aisle 5 is bounded in part on opposing sides by shelf structure 916 and shelf 906. Each shelf structure 908, 910, 912, 914, and 916 are logically (and perhaps physically) split in half (depicted in FIG. 9 with a dashed line, such as dashed line 918), one half facing one aisle, and the other half facing another aisle. In some embodiments, the user's cart 604 may be depicted in the map as well, such as shown in phantom by graphic 920. Such location data may be determined based on GPS, triangulation, among other location data with or without the use of nodes or RFID technology.

Each number in bold (numbers 1-12) in FIG. 9 corresponds to items in the shopping list. In some embodiments, the numerals may be replaced with other symbols or information, such as letters, abbreviations, and/or a short description of the product. The user may select one of the presented shopping list symbols (e.g., bolded 1-12) to discern additional information. For instance, the user may touch the bolded “1” on the display screen 701 of the smartphone 612, and a pop-up 922 (or other graphic for presenting the additional information) may be presented with certain real-time information, such as unit price, whether a coupon is available, among other information (e.g., complementary product offerings and location, unit price of the complementary products, as well as whether there are discounts (e.g., special deals, coupons, etc.) available for the complementary products, an option to price compare, etc.). In some embodiments, some of the additional information may be conveyed by the phone audibly, and/or through visual alterations of the various graphics. For instance, the bold numbering depicting the location of shopping list items may be colored differently or otherwise visually distinguished to represent whether coupons or other mechanisms for discounting are available.

The graphical user interface 900 comprises further functionality, such as button icons to change the view 924 (e.g., to show an aisle information view, such as shown in FIG. 7), search for product 926, or other functionality. For instance, though described in the context of a shopping list pre-configured prior to entry into the store, the user may decide there are items needed that he or she forgot during the initial configuration, and hence search for the locations of such items in the store. In such circumstances, the map may be further updated with additional symbols to show the location of these additional items. In some embodiments, the additional items may be shown in a manner that distinguishes from the items in the original shopping list. The other button icon 928 may be used to perform price comparisons with other alternative brands within the store (e.g., for items that were not part of the original list, though not exclusive to those items), or with the same or comparable product in other stores.

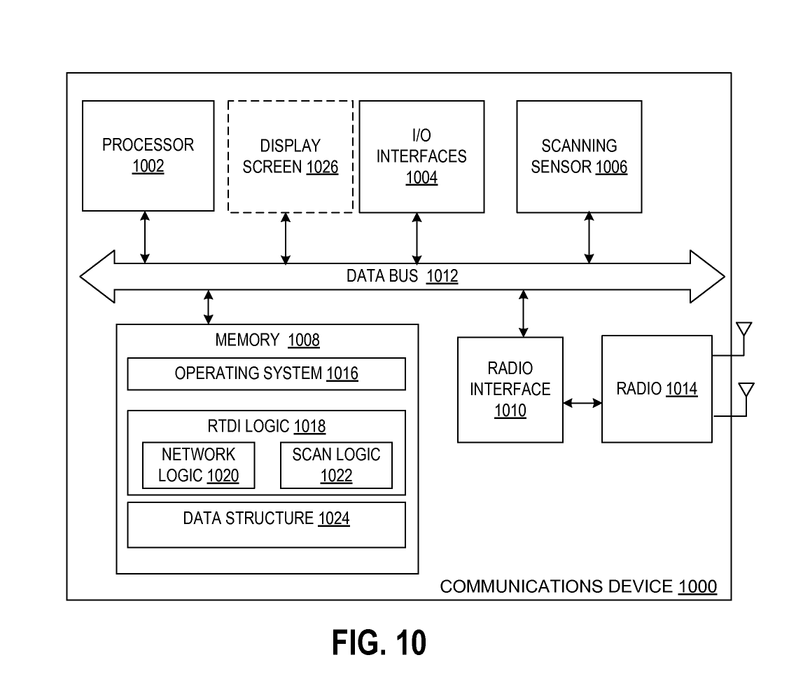

Referring now to FIG. 10, shown is an example embodiment of a wireless communications device 1000. The communications device 1000 may be embodied as a smartphone 612, one of the nodes, such as node 118, or other wireless communications devices. It should be appreciated that the architecture shown in FIG. 10 is merely illustrative, and that variations in architecture with similar or different components to achieve similar functionality (and additional functionality) are contemplated to be within the scope of the disclosure. The communications device 1000 comprises a processor 1002, input/output (I/O) interfaces 1004, a scanning sensor 1006, memory 1008, and a radio interface 1010, all coupled to a data bus 1012. The radio interface 1010 is further coupled to a radio 1014. The memory 1008 comprises an operating system 1016 and real-time digital inventory (RTDI) logic 1018. The RTDI logic 1018 comprises one or more firmware or software modules, including network logic 1020 and scan logic 1022. The memory 1008 further comprises one or more data structures 1024 (e.g., databases) for storing product information, discount information, among other information.

The radio 1014 comprises well-known transceiving functionality, which may include modulators (e.g., modulator and demodulators), converters (e.g., up- and downconverters), synthesizers (e.g., phase-locked loop circuitry), a power amplifier, various filters and switching components, and one or more antennas (e.g., single-input, single-output (SISO), multiple-input, or multiple-output (MIMO)). The radio interface 1010 enables the transition between digital and analog processing and generally serves to enable the software as executed by the processor 1002 to operate on the hardware level.

The processor 1002 may include any custom made or commercially available processor, a central processing unit (CPU) or an auxiliary processor among several processors associated with the communications device 1000, a semiconductor based microprocessor (in the form of a microchip), a macroprocessor, one or more application specific integrated circuits (ASICs), a plurality of suitably configured digital logic gates, and other well-known electrical configurations comprising discrete elements both individually and in various combinations to coordinate the overall operation of the computing system. In some embodiments, plural processors may be implemented, at least one of which includes a digital signal processor (DSP).

The memory 1008 may include any one of a combination of volatile memory elements (e.g., random-access memory (RAM, such as DRAM, and SRAM, etc.)) and nonvolatile memory elements. As indicated above, the memory 1008 comprises the operating system 1016 and one or more native applications, emulation systems, or emulated applications for any of a variety of operating systems and/or emulated hardware platforms, emulated operating systems, etc. For example, the applications may include application specific software, such as the network logic 1020 and the scan logic 1022.

The network logic 1020 comprises functionality to interact with the store network, operating in accordance with one or more network protocols, such as WiFi, 3G, 4G, Bluetooth, among others. Such functionality may include decoding and encoding, packetizing and depacketizing, quality of service (QoS) processing, RSSI processing, collision avoidance/mitigation, among other known network protocol and OSI-type processing. The network logic 1020 further comprises GPS and/or other triangulation functionality to enable the determination of the location of the communications device 1000 and/or product within a store. The network logic 1020 may further cooperate with a display screen 1026 (shown in phantom since for the node 118, such functionality may be omitted) to present a map of the store and the locations of the various products (e.g., on the shopping list or search for product). The network logic 1020 enables the communications device 1000 to communicate information (e.g., product information, such as unit price, descriptions, complementary product information, etc.) read from, or to be written to, the data structure 1024 and receive and/or send discount information (e.g., broadcast or unicast coupon information, special promotions or deals).

The scan logic 1022 comprises one or more drivers that cooperate with the scanning sensor 1006 to detect the scanning code of products that are located in the store, and includes functionality for RF-based (e.g., RFID, QR) scans and IR based scanning.

The data structure 1024 may be comprised of one or more data structures, the data structure 1024 comprising product information, and depending on whether embodied as a node or smartphone, may also comprise other information. For instance, where the communications device 1000 is embodied as a smartphone, the data structure 1024 may also comprise a profile of the user (e.g., name, credit card(s) or other financial information, address, store account number, etc.), shopping lists, digital coupons (e.g., digital coupons available to all at the store, consumer-directed coupons, second chance coupons, such as to track consumer triggers/price points for spontaneous/impulse buying opportunities), store map, competitive price information (e.g., from other stores or other products), shopping history, among other information. If the communications device 1000 is embodied as a node, the data structure 1024 may comprise quantities in stock of each product, as well as discount information (e.g., digital coupons, consumer-directed coupons, second chance coupons, special deals, etc.). The computational functionality of the processor 1002 enables the communications device 1000 (e.g., in the case of a smartphone) to compare the received real-time information (e.g., received from a node) to the product list in the shopping list stored in the data structure 1024 to determine a match, tally shopping list totals, compare pricing (e.g., to show the difference in price between products when compared with another brand or retail store). The RTDI logic 1018 further comprises functionality to evaluate the shopping list and make suggestions for complementary product offerings. In some embodiments, the RTDI logic 1018 may generate digital coupons in cooperation with the store network based on Al functionality determining shopping habits.

One of ordinary skill in the art should appreciate that the memory 1008 can, and typically will, comprise other components which have been omitted for purposes of brevity. Further, in some embodiments, one or more of the functionality illustrated in FIG. 10 and described above may be combined in a single component or module.

Note that the software logic, such as the RTDI logic 1018, is encoded (e.g., stored) in memory 1008 and executed by the processor 1002 under the control of the operating system 1016. In some embodiments, the operating system 1016 may be omitted. Note that in the context of this disclosure, in general, the memory 1008 comprises a non-transitory computer-readable medium that stores programs for use by or in connection with an execution system, apparatus, or device.

The I/O interfaces 1004 comprise various components used to communicate over a wired or wireless medium with other device, and include a USB connection, IDE connection, among others known to one having ordinary skill in the art.

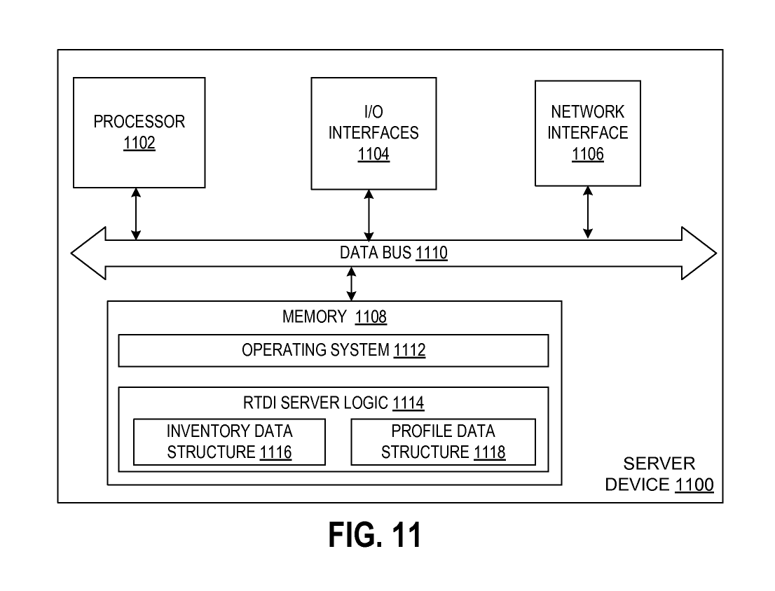

FIG. 11 shows one embodiment of a server device 1100, which comprises server functionality. The server device 1100 comprises an architecture that may be used for the main server device 102 and server devices 110 and 112. It should be appreciated that the architecture shown in FIG. 10 is merely illustrative, and that variations in architecture with similar or different components to achieve similar functionality (and additional functionality) are contemplated to be within the scope of the disclosure. The server device 1100 may, for instance, comprise a processor 1102, one or more input/output (I/O) interfaces 1104, a network interface device 1106, and a memory 1108 connected across a data bus 1110. The memory 1108 comprises, among other logic (e.g., software), an operating system 1112 and real-time digital inventory (RTDI) logic 1114, which includes in one embodiment, an inventory data structure 1116 and a profile data structure 1118.

The processor 1102 may include any custom made or commercially available processor, a central processing unit (CPU) or an auxiliary processor among several processors associated with the server device 1100, a semiconductor based microprocessor (in the form of a microchip), one or more ASICs, a plurality of suitably configured digital logic gates, and other well-known electrical configurations comprising discrete elements both individually and in various combinations to coordinate the overall operation of the server device 1100.

The memory 1108 may include any one of a combination of volatile memory elements (e.g., random-access memory (RAM, such as DRAM, and SRAM, etc.)) and nonvolatile memory elements (e.g., ROM, hard drive, tape, CDROM, etc.). The memory 1108 typically comprises the native operating system 1112, one or more native applications, emulation systems, or emulated applications for any of a variety of operating systems and/or emulated hardware platforms, emulated operating systems, etc. For example, the applications may include application specific software stored on a computer readable medium (e.g., memory, persistent storage, etc.) for execution by the processor 1102 and may include the RTDI logic 1114.

The RTDI logic 1114 includes the inventory data structure 1116 and the profile data structure 1118. The inventory data structure 1116 comprises an inventory of the products of the store, which is updated continually by the repeaters (e.g., repeaters 114 and 116 for store A). The inventory data structure 1116 includes product information and discount information (e.g., digital coupons as described herein, special deals, etc.) for the store products, as well as product information (e.g., unit price, product and brand description, discount information, etc.) for like product in other stores. For instance, when the server device 1100 comprises a store server device, such as server device 110, such related product information from other stores may be accessed from the main server device 102 (FIG. 1), or in some embodiments, residing in the server device of the store permanently based on uploads by store employees or other parties.

The profile data structure 1118 comprises information of each registered consumer, such as personal information (e.g., name, address, etc.) and financial information (e.g., optional to the user). The profile data structure 1118 may also comprise the shopping lists (e.g., past and present) of each user, as well as a map of the store with the locations of the shopping list items. The map may be downloaded to the user's smartphone upon the user entering the store, or in some embodiments, downloaded to the smartphone during the initial shopping list configuration (e.g., if done at home, via a download from the server device 110 to the computer 104 and then the smartphone 216).

One of ordinary skill in the art will appreciate that the memory 1108 may, and typically will, comprise other components which have been omitted for purposes of brevity, or in some embodiments, may omit certain components, such as server functionality (not shown).

Input/output interfaces 1104 provide any number of interfaces for the input and output of data. For example, data may be loaded manually via a keyboard, a mouse, etc. coupled to the input/output interfaces 1104. The input/output interfaces 1104 may further include one or more disc drives (e.g., optical disc drives, magnetic disc drives) to enable playback of data content residing on a computer readable medium (not shown).

The network interface device 1106 comprises various components used to transmit and/or receive data over a network environment, such as to receive and send information to the repeaters. By way of example, the network interface device 1106 may include a device that can communicate with both inputs and outputs, for instance, a modulator/demodulator (e.g., a modem), wireless (e.g., radio frequency (RF)) transceiver, a telephonic interface, a bridge, a router, network card, etc. The server device 1100 may further comprise mass storage (not shown). For some embodiments, the mass storage may include a data structure (e.g., database) to store product data (e.g., unit pricing, product descriptions, including brand name, discount information, etc.) corresponding to other stores, shopping history among the registered users, past shopping lists, among other information.

In the context of this disclosure, a “computer-readable medium” stores one or more programs and data for use by or in connection with the instruction execution system, apparatus, or device. The computer readable medium is non-transitory, and may be, for example, but not limited to, an electronic, magnetic, optical, electromagnetic, infrared, or semiconductor system, apparatus, or device. More specific examples (a non-exhaustive list) of the computer-readable medium may include, in addition to those set forth above, the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), and a portable compact disc read-only memory (CDROM) (optical).

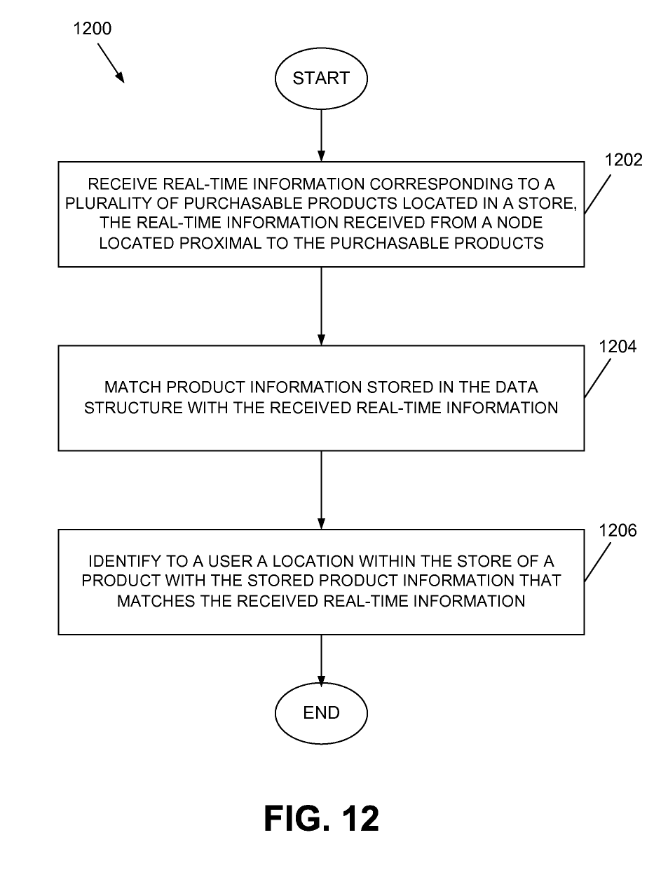

Having described certain embodiments of a real-time digital inventor system, it should be appreciated within the context of the present disclosure that one real-time digital inventory method 1200, shown in FIG. 12 and implemented at a communications device 1000 embodied as a smartphone or other user device, comprises receiving real-time information corresponding to a plurality of purchasable products located in a store, the real-time information received from a node located proximal to the purchasable products (1202); matching product information stored in the data structure with the received real-time information (1204); and identifying to a user a location within the store of a product with the stored product information that matches the received real-time information (1206).

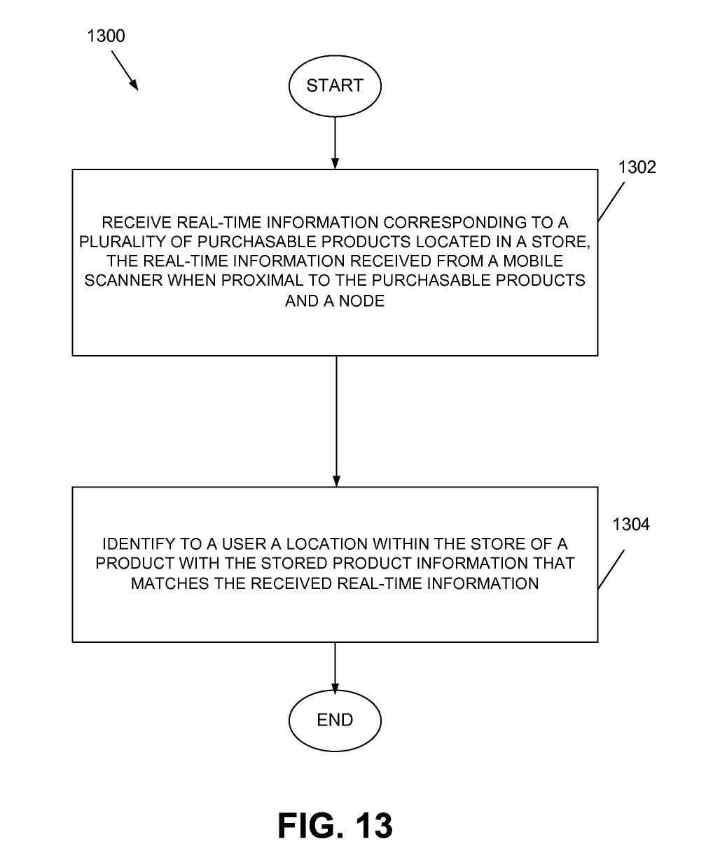

It should be appreciated within the context of the present disclosure that one real-time digital inventory method 1300, shown in FIG. 13 and implemented at a communications device 1000 embodied as a node, comprises receiving real-time information corresponding to a plurality of purchasable products located in a store, the real-time information received from a mobile scanner when proximal to the purchasable products and the node (1302); and transmit the real-time information over a wireless network to a first communications device associated with a consumer, the transmission responsive to the consumer located proximally to the node (1304). The wireless network may comprise a WiFi network, 3G network, 4G network, Bluetooth, among others.

Note that the communications device 1000 may be implemented in hardware, software, firmware, or a combination thereof. When one or more of the real-time digital inventory functionality is implemented in logic configured in software or firmware, the software or firmware is stored in a memory and executed by a suitable instruction execution system. When one or more of the real-time digital inventory functionality is implemented in logic configured in hardware, the hardware can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow diagrams should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present invention.

The aforementioned embodiments focus on real-time digital inventory architectures and/or methods that utilize RFID transmitters. However, one having ordinary skill in the art, in the context of the present disclosure, should appreciate that some embodiments may omit the RFID transmitters. For instance, in one embodiment of a real-time digital inventory, all information regarding database information including, but not limited to, coupons, prices, deals, offers and any other relevant data is stored in a third party proprietary server device. A customers' location in the store may be determined using WiFi triangulation methods. In one embodiment, multiple separate WiFi routers may send the same signal in different strengths to pinpoint or at least closely approximate the location of the user (e.g., shopper, customer, etc.). In such embodiments, RTDI logic embodied as a mobile phone application downloads all data stored on the proprietary server device in respect to the store onto the smartphone. This data may include all forms of coupons, deals and specials available exclusively to that store location. By using WiFi triangulation and relevant shelf data, the mobile phone application may produce a populated store map with information of each item in a specific aisle in the store. In one embodiment, the store map may be created using a “sparse matrix” to populate certain quadrants with specific coupons or deals. The RTDI logic embodied as a mobile phone application may integrate a web based shopping list with available deals. For instance, in one scenario, while populating the shopping list with each item, the proprietary service provides the first available coupon or deal that relates to that item. So, if a user types in “milk,” a coupon/deal for $1 off Brand A milk populates the program, and the coupon/deal is saved on a shopping list/wallet type application. The user can then redeem this deal in relation of the limitations specified by the coupon.

In some embodiments, the third party providing the proprietary server device may track user shopping preferences and detail and track items and times of shopping. for instance, the user may populate mobile phone application by entering information pertaining to goods into the web based shopping list. That data may be utilized to forecast sales on specific items, and provide times and preferences to launch virtual deals. For example, assume there are N registered users on the service, where N is a non-negative integer (e.g., 30,000). After two weeks of data collection, certain embodiments of a real-time digital inventory system may analyze all the data in relation to deals, coupons, items on the shopping list, and/or most popular coupons to create a detailed marketing report on user data. So, out of N users, an embodiment of the real-time digital inventory system may identify trends such as what item is the most popular, when customers redeem these deals, peak shopping times, and other relevant data that may be used to market products in the system. This data is based off a concept referred to as “Incentive Based Marketing”, where by using coupons as advertisements, the hope is to create a value added approach to retail shopping.

In some embodiments of real-time digital inventory systems, coupons may be used to create incentive based couponing and marketing. For instance, one embodiment of the RTDI logic embodied as a mobile application that enables mobile access of information housed on the third party proprietary server device. The server device stores a variety of manufacturers' coupons, local retail deals and exclusive deals that the consumer would not have access to otherwise. By enabling access to the stored information, the shopper may save money every time he or she enters a retail grocery store. These savings may arise from manufacturers coupons, specific store deals, and/or target couponing exclusive to the third party. Without the mobile application, the user cannot have access to such information.

Certain embodiments of real-time digital inventory systems and methods address one or more perceived shortcoming to existing retail schemes. For instance, there is generally more people shopping online than in the store, and consumers are not finding savings or value added reasons for in-store retail shopping. Further, most methods of finding savings are time consuming and not natural, including reliance on barcode scanners, Groupon, searching the Internet independently for coupons. In contrast, certain embodiments of a real-time digital inventory system and method may draw shoppers back to the store by removing or mitigating the perceived shortcomings of couponing. Further, one or more embodiments of a real-time digital inventory system may use couponing as an incentive based marketing tool, create a data structure (e.g., database) of a multitude of manufacturer's coupons and in-store deals, use information generated to create marketing information on shopper habits, trending coupons and targeted marketing based on established trends. Manufacturers may benefit from one or more embodiments. For instance, manufacturers produce various coupons each year that go unused, and already set coupons to be credited in any location selling the product. Such manufacturers want coupons to be used. Supplier/Retail stores also may benefit, such as by advertising in the form of savings. Indeed, information is already used in flyers, store ads etc.

Using WiFi triangulation and a sparse matrix, triggered marketing may be created and utilized in specific store quadrants to enhance the user experience. Compared to some conventional systems (e.g., some applications let users scan the barcode of items in order to retrieve relevant pricing information), certain embodiments of a real-time digital inventory system incentivizes each user to use the RTDI logic in his or her smartphone to save money within the store, thus eliminating the consumer need to find a better deal. In other words, the user receives the best possible deals for shopping at that location.

It should be emphasized that the above-described embodiments of the present disclosure are merely possible examples of implementations, merely set forth for a clear understanding of the principles of the disclosure. Many variations and modifications may be made to the above-described embodiment(s) without departing substantially in spirit or principle. All such modifications and variations are intended to be included herein within the scope of this disclosure and protected by the following claims.

At least the following is claimed:

1. A system, comprising:
a communications device, comprising:
a memory comprising logic and a user-configured data structure; and
a processor configured with the logic to:
receive real-time information corresponding to a plurality of purchasable products located in a store, the real-time information received from a node located proximal to the purchasable products;
match product information stored in the data structure with the received real-time information; and
identify to a user a location within the store of a product with the stored product information that matches the received real-time information.

2. The system of claim 1, wherein the processor is configured with the logic to receive the real-time information without active user solicitation of the real-time information.

3. The system of claim 1, wherein the processor is configured with the logic to receive the real-time information wirelessly.

4. The system of claim 1, wherein the processor is configured with the logic to receive the data structure at the store responsive to the communications device attaining a location within the store.

5. The system of claim 1, wherein the processor is configured with the logic to receive the data structure at a location outside of the store.

6. The system of claim 1, wherein the real-time product information is embodied as a unique scanning code.

7. The system of claim 6, wherein the scanning code comprises a radio frequency identification (RFID) code or a QR code.

8. The system of claim 1, wherein the processor is configured with the logic to identify the location by showing a graphic on a display screen of the communications device indicating the location of the product relative to the user's current location.

9. The system of claim 1, wherein the processor is configured with the logic to identify the location by showing the location on a display screen of the communications device.

10. The system of claim 1, wherein the processor is configured with the logic to identify the location by audibly indicating the location to the user.

11. The system of claim 1, wherein the processor is configured with the logic to receive a map of the store with plural locations for plural products corresponding to stored product information identified, the processor configured with the logic to provide on the display screen the map in a plan view with structures in the format of geometric objects, with the location of each of the products identified in the display screen relative to the structures.

12. The system of claim 1, wherein the processor is configured with the logic to alert the user to discount information.

13. The system of claim 12, wherein the processor is configured with the logic to alert the user without active solicitation by the user or responsive to active solicitation by the user.

14. The system of claim 12, wherein the discount information is for one or more of products corresponding to products in the data structure and for complementary products that do not have product information as part of the data structure.

15. The system of claim 1, further comprising a cart, wherein the processor is configured with the logic to track which products in the store are placed in the cart.

16. The system of claim 15, further comprising a cradling device attached to the cart.

17. The system of claim 16, wherein the cradling device is configured to detachably receive and secure the communications device to the cart.

18. The system of claim 17, further comprising a charging apparatus operably coupled to one or more wheels of the cart and the cradling device, the charging apparatus configured to charge the communications device based on energy caused by rotation of the one or more wheels.

19. The system of claim 15, wherein the communications device is integrated with the cart.

20. The system of claim 1, further comprising a shopping bag, the shopping bag configured with a sensor to detect product that enters the shopping bag, wherein the processor is configured with the logic to track which products in the store are placed in the bag responsive to a signal from the sensor.

21. The system of claim 1, wherein the processor is configured with the logic to tally in real-time an accumulated price for products in possession of the user.

22. The system of claim 1, wherein the processor is configured with the logic to perform product searches, price comparisons, or a combination of both.

23. A system, comprising:
a node comprising a scanning sensor, the node configured to:
receive real-time information corresponding to a plurality of purchasable products located in a store, the real-time information received from a mobile scanner when proximal to the purchasable products and the node; and
transmit the real-time information over a wireless network to a first communications device associated with a consumer, the transmission responsive to the consumer located proximally to the node.

24. The system of claim 23, wherein the node is further configured to transmit the real-time information to a second communications device.

25. The system of claim 24, wherein the second communications device comprises a repeater.

26. The system of claim 23, wherein the scanning sensor comprises either a radio frequency identification (RFID) sensor or a QR sensor.

27. The system of claim 23, wherein the data structure stores the real-time information, the real-time information consisting of product information for the purchasable products that are proximal to the node.

28. The system of claim 27, wherein the purchasable products that are proximal to the node consist of products located in a single aisle.

29. The system of claim 27, wherein the purchasable products that are proximal to the node consist of products located in a single aisle.

30. The system of claim 27, wherein the product information comprises one or more of unit price, unit descriptor, product identity, product brand name, coupon information, complementary product identification and associated information of the complementary product, and competitive information.

31. The system of claim 29, wherein competitive information comprises one or more of unit price information for the same product in a different store and unit price information for the same type of product of a different brand in the same store.

32. The system of claim 23, further comprising a server device and a repeater, the server device configured with memory, the memory comprising a profile data structure and an inventory data structure, wherein the node is further configured to transmit the real-time information to the repeater, and the repeater updates the inventory data structure with the real-time information.

33. The system of claim 23, further comprising a TTI system, the TTI system comprising logic configured to acquire in real time local environmental conditions, store the conditions, and wirelessly transmit information to another device for transformation of raw data.

34. The system of claim 23, wherein the another device is configured to transmit the transformed data for display on a graphical user interface (GUI), the GUI configured to provide an indication of freshness and/or suitability of the monitored product for use or consumption following transportation, storage, or both.

35. A system, comprising a TTI system as disclosed herein.

36. The system of claim 35, further comprising a real-time digital inventory system integrated with the TTI system.
